(19) United States
(12) Patent Application Publication
(10) Pub. No.: US 2018/0296426 A1
(43) Pub. Date: Oct. 18, 2018

(54) APPARATUSES, SYSTEMS AND METHODS FOR CONTROLLING EXOSKELETONS

(71) Applicant: ReWalk Robotics LTD., Yokneam (IL)

(72) Inventor: Lilach Havida KAPPEL, Tzur Yitzhak (IL)

(73) Assignee: ReWalk Robotics LTD., Yokneam (IL)

(21) Appl. No.: 15/768,484

(22) PCT Filed: Oct. 16, 2016
(86) PCT No.: PCT/IL2016/051125

§ 371 Date: Apr. 13, 2018

Related U.S. Application Data
(60) Provisional application No. 62/242,780, filed on Oct. 16, 2015.

(51) Int. Cl. A61H 3/02

(52) U.S. Cl. CPC A61H 3/02; A61H 2201/164; A61H 2003/001; A61H 2201/5071; A61H 2201/501

(57) ABSTRACT

In some embodiments, apparatus and systems for controlling exoskeleton devices, and more particularly, smart crutches configured for sensing an environment and processing the sensed data to control the movement of exoskeleton devices over various types of surfaces are presented. In some embodiments, the smart crutches may comprise sensors configured to sense the state of the exoskeleton, the crutches and the surrounding environment, and to transmit such measurements to various components of the crutch and/or exoskeleton such as processing units, user interfaces, etc. In some embodiments, the processing unit may generate instructions for the exoskeleton and/or the crutches to carry out based on the measurements.

### CROSS REFERENCE TO RELATED APPLICATIONS

This application claims priority to U.S. Provisional Patent Application No. 62/242,780, entitled “Apparatus and Systems for Controlling Exoskeletons,” filed Oct. 16, 2015, the disclosure of which is incorporated by reference herein in its entirety.

### FIELD OF THE DISCLOSURE

Embodiments of the current disclosure are directed toward exoskeleton devices for providing gait/movement assistance, and more particularly, methods and apparatus for controlling such devices.

### BACKGROUND

Various conditions contribute to the occurrence of disabilities in individuals that restrict or eliminate the individuals' capabilities for steady gait and/or movement, examples of which include neurological and physical injuries. Exoskeletons (“external skeletons”) have been used to allow such individuals regain some or all of their capabilities to stand and/or move about with little or no additional support despite their disabilities.

### SUMMARY OF SOME OF THE EMBODIMENTS

In some embodiments of the present disclosure, a crutch apparatus for at least aiding in the control of mobility of an exoskeleton device is provided and includes an elongated structural member configured with a first portion for grasping by a user of an exoskeleton device and a second portion configured to interact at least with a surface, one or more first sensors for outputting signals corresponding to information of at least one of a location and a distance of the one or more sensors and/or crutch relative to at least one of a position, a location, and a surface, and outputting signals indicative thereof, and communications means for communicating the signals to a processing unit.

The above-noted embodiments may further include one and/or another of the following additional features, functionality, and/or refinements:
the processing unit (which may be provided on either or both of the crutch apparatus and the exoskeleton device, and/or tethered or untethered unit);
the communications means (e.g., a transceiver to receive and/or transmit signals which may correspond to information/data, and may be via digital communications or analog), which may be operably coupled to at least one of the crutch, the exoskeleton device, and a remote unit;
the information corresponds to at least a distance between at least two of: the crutch, the ground, a second crutch, a horizontal surface, a lateral surface, and at least a portion of the exoskeleton device;
the information corresponds to at least a location of at least one of the crutch, the ground, a second crutch, a horizontal surface, a lateral surface, and at least a portion of the exoskeleton device;
the processing unit includes computer instructions operating thereon configured to at least one of process the signals and generate further instructions to control at least a mobility of the exoskeleton device(the instructions can be configured to control at least a mobility of the exoskeleton device is based on the signals);
one or more control elements (e.g., touchscreen device like a smartphone (e.g., computer or processor with at least input means) which may be affixed to the crutch or the exoskeleton, or, a specific dedicated box with physical buttons for selecting and/or inputting information) configured to allow a user of the exoskeleton device to control at least one of a state of the exoskeleton device, a state of the crutch, and a state of a third device, where the state may be one or more of on, off, stand-by, walk, sit, climb, stair, and velocity of the exoskeleton device;
the one or more first sensors (or any sensors for use in disclosed embodiments) may comprise at least one or more of: pressure sensors, GPS sensors, gyroscopic sensors/devices, and radio-ID sensors/devices, acoustic sensors, light sensors;
the one or more first sensors are arranged at or near a distal end of the crutch and may be configured to at least sense contact or proximity of the distal end of the crutch with at least one of the ground, horizontal surface, and lateral surface and generate the signals responsive thereto;
the location or distance information comprises at least one of a size and shape of an obstacle on a pathway of at least one of the crutch and the exoskeleton device;
the location or distance information comprises a height of a stair on a pathway of at least one of the crutch and the exoskeleton device;
the one or more first sensors may be configured to communicate with one or more second sensors of a second crutch via at least one of the communications means and second communication means—where the second crutch may include second crutch communications means for communicating with at least one of the communications means and/or second communication means of the crutch, and the processing unit;
the one or more second sensors of a second crutch (or other independent item) generate second signals comprising information corresponding to at least one of location and distance of at least one of the one or more second sensors and at least a portion of the second crutch—the processing unit may include computer instructions operating thereon configured to at least one of process the signals from the one or more sensors, and the signals of the one or more second sensors of the second crutch and generate further instructions to control at least a mobility of the exoskeleton device;
the processing unit may include computer instructions operating thereon configured to at least one of process signals from the one or more sensors, and signals from the one or more second sensors of the second crutch and determine an offset distance between at least two of the crutch, the second crutch, and the exoskeleton device, where the offset distance can comprise at least one of an elevation difference and a lateral distance; and
a user interface configured to at least one of: display information, provide data input, control and/or select a state of at least one of the crutch, a second crutch and the exoskeleton device;

In some embodiments, a system for enhancing mobility of a user is provided and includes an exoskeleton device and one or more crutches according to any of the proceeding embodiments and optional noted additional elements, functionality and/or refinements.

In some embodiments, a method for operating an exoskeleton device is provided and comprises providing one or more crutches according to any of proceeding embodiments (or any disclosed crutch embodiments), sensing by the one or more first sensors at least one of a location and a distance of the one or more sensors and/or crutch relative to at least one of a position, a location, and a surface, outputting signals indicative of information of at least one of the location and the distance, and communicating the signals to a processing unit.

The above-noted embodiments may further include one and/or another of the following additional features, functionality, and/or refinements:
operably coupling the communication means to at least one of the crutch, the exoskeleton device, and a remote unit;
the signals correspond to at least a distance between at least two of: the crutch, the ground, a second crutch, a horizontal surface, a lateral surface, and at least a portion of the exoskeleton device;
the signals correspond to at least a location of at least one of the crutch, the ground, a second crutch, a horizontal surface, a lateral surface, and at least a portion of the exoskeleton device;
processing the signals and generating further instructions to enable the processing unit to control at least a mobility of the exoskeleton device, where the instructions to control at least a mobility of the exoskeleton device is based on the signals;
controlling at least one of a state of the exoskeleton device, a state of the crutch, and a state of a third device, where the state may be selected from any of on, off, stand-by, walk, sit, climb, stair, and velocity of the exoskeleton device;
sensing comprising sensing contact or proximity of at least a portion of the crutch with at least one of the ground, horizontal surface, and lateral surface;
the location or distance information may comprise at least one of a size and shape of an obstacle on a pathway of at least one of the crutch and the exoskeleton device or a portion thereof;
the location or distance information may comprise a height of a stair on a pathway of at least one of the crutch and the exoskeleton device;
communicating the signals to one or more second sensors of a second crutch via at least one of the communications means and second communication means;
the second crutch includes second crutch communications means for communicating with at least one of the communications means and/or second communication means of the crutch, and the processing unit;
generating second signals from the one or more sensors of a second crutch, the signals comprising at least one of location information and distance information, and optionally processing the signals from the one or more sensors, and the signals of the one or more second sensors of the second crutch, and controlling at least a mobility of the exoskeleton device based on the processed signals;
processing signals from the one or more sensors and signals from the one or more second sensors of a second crutch and determining an offset distance between at least two of the crutch, the second crutch, and the exoskeleton device, where the offset distance comprises at least one of an elevation difference and a lateral distance; and
controlling and/or selecting a state of at least one of the crutch, a second crutch and the exoskeleton device.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1A is a schematic illustration of an exoskeleton device according to some embodiments of the present disclosure.

FIG. 1B is a schematic illustration of a smart-crutch that can be used for controlling an exoskeleton (a portion of which is shown in this figure), according to some embodiments of the present disclosure.

FIG. 2 is a flow diagram illustrating an exemplary use of smart-crutches in controlling the movement of an exoskeleton over various surfaces, according to some embodiments of the present disclosure.

### DETAILED DESCRIPTION OF SOME OF THE EMBODIMENTS

In some embodiments of the present disclosure, apparatus and systems for controlling exoskeleton devices, and more particularly, smart-crutches configured for sensing an environment and processing the sensed data to control the movement of exoskeleton devices over various types of surfaces are presented. Although amenable to various applications, specific embodiments are described herein, by way of example and not limitation, in order to illustrate the principles and features of the invention.

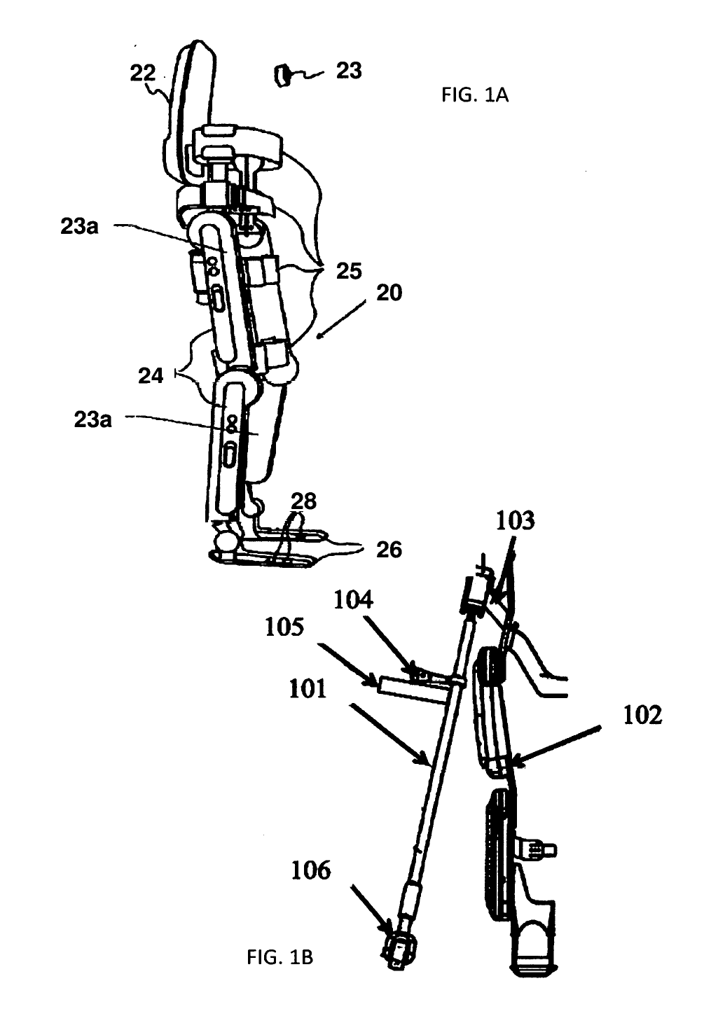

FIG. 1A shows a motorized locomotion assisting exoskeleton device (which may be referred to as simply exoskeleton device) that is controlled in accordance with at least some embodiments of the present disclosure. Locomotion assisting exoskeleton device 20 is powered and controlled by controller pack 22 which incorporates a controller in the form of a processor (which may also be referred to as a processing unit, and may be programmable), and a battery or other power supply, as well as other possible structure (e.g., communication devices such as a transceiver, for at least one of wirelessly transmitting and receiving signals/data/information to another device or portion of the exoskeleton). Controller pack 22 is generally worn on the back of a person using locomotion assisting exoskeleton device 20. Alternatively, the various components of controller pack 22 may be attached to or incorporated in various components of exoskeleton device 20. For example, components of controller pack 22 may be incorporated into braces 24.

Controller pack 22 may communicate with one or more sensors, for example, sensor(s) 23 (e.g., a tilt sensor, pressure sensors, radio ID sensors/tags, light sensors, acoustic sensors, and the like), which may be affixed to an applicable location somewhere on the exoskeleton and/or an associated device/apparatus (e.g., crutch, smartphone, computer and the like). Other types of sensors which may be included in the exoskeleton or other embodiments of the present disclosure include accelerometers, gyroscopes, or any other sensors capable of being used.

Braces 23a are affixed by means of straps 25 (for example) to segments of the user's lower limbs and to the pelvis, torso, or other parts of the user's body. Braces 23 incorporate motorized actuation assemblies 24. Each actuation assembly 24 includes a motorized actuator (not shown) that, in response to commands transmitted by controller pack 22, causes a joint that connects between individual braces 23a to bend or extend. Bending or extending a joint may propel or move a limb to which an adjoining brace is attached. When the lower limbs of the user are affixed to braces 23a, each of the user's feet is placed on a foot brace 26. Foot brace 26 may be movable by means of a separate motorized actuation assembly (not shown) to lift, guide, and lower a foot of the user. Alternatively, foot brace 26 may include a coil, spring, or other elastic anti-drop mechanism associated with ankle joint 27. The anti-drop mechanism associated with ankle joint 27 holds foot brace 26 substantially horizontal when foot brace 26 is raised above, and is not supported by, a supporting surface.

With reference to FIG. 1B, in some embodiments, a mobility aid 101 is provided, examples of which include one or more crutches, strutters, auxiliary-crutches, braces, props, canes, and/or crutch-like devices (hereinafter each and all may be referred to as a crutch(es)) that may be used with an exoskeleton device 102 as shown (one brace for one leg illustrated; it will be appreciated that the exoskeleton of FIG. 1A can be the exoskeleton for which the crutch(es) are used/associated with). While only a single crutch is shown, some embodiments of the present disclosure may include a plurality of crutches (i.e., two or more). In some embodiments, one or more crutches may integrally be part of the exoskeleton device (e.g., monolithically connected via fasteners or connecting structure), and in some embodiments, the one or more crutches may be detachably connected to the exoskeleton device or unconnected to the exoskeleton when the exoskeleton is in use. For example, crutches may be connected to the exoskeleton via a coupling unit 103 that connects the crutches to the exoskeleton device. In some embodiments, the crutches may be coupled or connected to the user of the exoskeleton device, for example, as part of a torso support component of the exoskeleton device. The coupling unit may be able to expand, contract, change its orientation, twist or otherwise change its shape and configuration in adapting to the surrounding environment and allowing the exoskeleton/user to maneuver in such environments. In some embodiments, there may be two crutches configured for use with an exoskeleton. In some embodiments, this pair of crutches may be independent of each other or connected to each other.

The crutch 101 may include a handle (which may also be referred to as a grasping/grabbing portion) 104 for a user to grasp hold off with a hand, and distal portion 106 which can be a post/cap, or a wheel (such wheel or post/cap may also include sensor—e.g., pressure, rolling distance, etc.). Crutch 101 may also include control unit 105, which

In some embodiments, a crutch(es) may comprise locomotion components configured to allow, facilitate, enhance, hinder, terminate, or otherwise manage movement of the crutch over various types of surfaces. For example, crutches may include locomotion components such as wheels (powered or unpowered), holders, etc., at the distal end (for example) of the crutch that are configured to interact with surfaces to facilitate the mobility of the crutch on a surface. In some embodiments, the components may be used to stabilize the crutch with respect to a surface.

In some embodiments, a crutch(es) may include one or more sensors configured to sense a variety of data about the exoskeleton, the crutch, the surrounding environment, and/or the like. For example, a crutch may include sensors capable of sensing the mobility state of the crutch and/or exoskeleton associated with the crutch including speed (linear and/or angular, for example), orientation, direction, tilt, location, elevation, etc. For example, crutches may include at their distal end (or any position to attain the best indication of a condition) sensors capable of recognizing when the crutch/distal end (e.g., the locomotion component) makes contact with a surface—e.g., the ground, a floor, a stair, a lateral surface. An example of such a sensor may be a pressure sensor and/or a proximity sensor (see types of sensors listed above for any of a crutch or exoskeleton device). In some embodiments, crutches may include sensors configured to allow the determination of a crutch's location (or a portion thereof), a distance between items (e.g., the crutch and the floor, the exoskeleton device, the wall, an obstacle) and/or characteristics of the location. For example, crutches may comprise GPS sensors capable of identifying the location of the crutch (e.g., with respect to the exoskeleton). As another example, crutches may include sensors such as temperature sensors, pressure sensors, etc., for sensing various characteristics of the location of the crutch such as, but not limited to altitude, presence of obstacles, elevation of the crutch with respect to some reference point, and/or the like. Examples of such sensors include orientation sensors, altitude sensors, etc.

In some embodiments, one or more sensors on two different portions of a crutch or arranged on two different crutches being used with an exoskeleton device may be able to communicate with each other via a transceiver (i.e., well known communication means in the art, including digital communications wifi and Bluetooth, for example). In some instances, such communication may allow the sensors to sense and/or make determinations that otherwise may be difficult to make with only a single sensor in one crutch. For example, the elevation offset of one crutch with respect to the other may be determined from location measurements performed by both sensors (i.e., a sensor in each crutch of the pair of crutches). In such embodiments, the sensors may use one of them as reference points in determining the elevation offset between the two crutches. For example, when a user of an exoskeleton device is attempting to climb stairs, a distal end of the first crutch may rest on a first stair and a distal end of the second crutch may rest on a second step. Sensors for each crutch may gather data and/or otherwise determine various information on the location, characteristics (e.g., elevation, width), etc., of the stairs. In some embodiments, the sensors may be able to communicate with each other the gathered or sensed data/information, and the elevation offset between the crutches (which, in some instances, may approximate the height of the stairs) may be determined by either sensor from the difference between each sensor's elevation measurements. In some embodiments, the sensors may be capable of making additional determinations from the gathered data/information such as, but not limited to, planar offsets between the crutches, nature of obstacles in the vicinity of the crutches, etc. For example, for a pair of crutches where each sensor is placed at one corner of a puddle of water, the sensors may determine the distance between the two crutches, and as a result determine the width of the puddle (such information can then be used by a processing unit when assessing how to avoid the puddle, for example).

In some embodiments, there may be additional sensors located at various locations on the exoskeleton device itself or in a room, hallway, road, and the like, and such sensors may also be used in making measurements, distances, locations, and determinations as disclosed in the previous paragraph. For example, the measurements of one or more sensors located on the exoskeleton may be used as reference points when the sensors located on the crutches make determinations related to the height of a stair the user of the exoskeleton is climbing. As an illustration, a height measured by one or more sensors in the exoskeleton can be used as a reference height, and the height of the sensors located at the crutches may be measured with respect to this reference height. If one crutch is located at the top of the stair and the other at the bottom, the difference of the heights of the crutches measured as described can then be considered to correspond to (e.g., be substantially equal to) the height of the stair.

In some embodiments, crutches may comprise sensors configured to sense the surface topography of the vicinity of the distal ends of the crutches. For example, crutches may include sensors capable of outlining the shape and/or extent (e.g., height, width, etc.) of the surface on which the crutches are resting or near. Such sensing may allow the sensor to determine if there is any obstacle for the crutches, the exoskeleton and/or the user in traversing along the surface. For example, a camera, a proximity sensor (e.g., optical sensor, sonar sensor, etc.) and the like may indicate various impediments along the path of the user, such as an obstacle, a surface with steep grade, a rough surface terrains, etc., and such information may be used by the user in adjusting the user's gait to avoid the impediment. For example, a proximity detector in one of the pair of crutches may indicate the presence of a high obstacle in front of the crutch, while a second proximity detector in the second of the pair may not indicate any obstacles in its vicinity. Such information may allow the exoskeleton to adjust its direction away from the obstacle, thereby facilitating the movement of the user/exoskeleton by overcoming/avoiding obstacles. In some embodiments, sensors in both crutches may detect the presence of obstacles to the movements of the user of the exoskeleton. The sensors may also be able to determine additional information about the obstacle, such as but not limited to the distance to the obstacle, its size (height, width, depth, etc.), shape, and/or the like. In some embodiments, from these and/or additional information, a processing unit and/or the sensors may determination adjustments in movement direction, speed, orientation of the exoskeleton, etc., that would avoid the obstacle.

In some embodiments, the gait profile and/or gait parameters such as, but not limited to, speed, direction, orientation, etc. of the exoskeleton may be controlled and/or adjusted based on the state of the crutch itself. For example, sensors disposed in the crutch and/or the exoskeleton may measure and/or determine data on the static or mobility state of the crutch. In such embodiments, the data may include information on the distance, direction, height, orientation, etc., of the crutch itself when it is under use by the user of the crutch, for example. From this data, in some embodiments, one may determine and control and/or adjust the gait parameters of the exoskeleton including speed, direction, orientation, etc. For example, if the user of the crutch shifts the direction of the crutch by some degrees while displacing the distal end of the crutch by a desired distance, sensors disposed in the crutch and/or the exoskeleton may gather such data for use in determining the exoskeleton gait parameters that correspond to the movement of the crutch (e.g., if the user of the exoskeleton/crutch orients the crutch about 30° from the direction of the user's travel and moves the crutch by a meter, such data as gathered by sensors in the exoskeleton and/or crutch may allow the exoskeleton to adjust its gait so as to match the movement of the crutch by turning by about same degrees and taking the appropriate sized step). Such determinations may be performed by the sensors and/or a processing unit of the crutches and/or the exoskeleton device.

In some embodiments, the handle 104 of the crutch(es) may include at least one of input and output means, which may be configured with structure, electronics and the like for controlling the actions of the crutch, the movement of the exoskeleton, and/or for interacting with the exoskeleton (e.g., by the user), or for emergency and other diagnostic and reporting services. In some embodiments, such functionality may be included in a user-interface/control device either on the handle, or proximate thereto. For example, as shown in FIG. 1B, such input/output means/control may be in the form of a user interface configured to, for example, receive input data from the user of the crutches/exoskeleton, as well as present data. Such means may be a smartphone which can be affixed and paired to the controller and/or sensors of one or more of the crutch(es) and exoskeleton (or other device, including, for example, sending information to a remote server for analysis and the like).

For example, in some embodiments, the user may be about to ascend or descend stairs, and may wish to determine the height of the stairs. In such embodiments, the user may place a crutch on each stair of a pair of consecutive stairs, and input into the user interface a selection (e.g., select an icon on the user interface) to initiate a measurement of the height of the stairs. The selection may trigger sensors disposed in the crutches to perform location measurements so as to determine the elevation offset between the crutches. The determined offset may then be related to a height of the stairs. For example, the offset may be at least substantially equal to the height, and/or the height may be related to and can be determined from the offset based on some relationship. In some embodiments, the offset and/or the deduced height may then be displayed on the user interface, and further used (e.g., by the processing unit) in assessing how to adjust the gait of the exoskeleton so as to allow the user to ascend or descend the stairs safely and efficiently.

In some embodiments, the handle may comprise control elements that allow the user to control the functioning of the exoskeleton. For example, the handle may include one or more control elements configured to control the state of the exoskeleton, including the powering on/off of the exoskeleton, and its speed and direction. The control elements, examples of which include buttons, triggers, etc., may include sensors (e.g., force sensitive resistors) for detecting pressure from the user's fingers, and the magnitude of the pressure may be used as a measure of change in a value mandated by the user. For example, a handle of a crutch may comprise one or more buttons for changing the velocity of the exoskeleton, and the user may engage these buttons when using the exoskeleton to increase or decrease the speed and/or change the direction of movement of the exoskeleton. For example, the user may utilize these control buttons in avoiding obstacles sensed by sensors at the distal ends of the crutches. As another example, the control buttons may be used to control and adjust the gait profile of the exoskeleton so as to effect the aforementioned safe and efficient climbing of stairs.

In some embodiments, the data gathered by the various sensors of the crutches may be transmitted to a processing unit onboard the crutches (e.g., at the handle), at a controller pack of the exoskeleton device, a mobile device/smartphone and/or an external server for processing. For example, once sensors at the crutches gather data on the height of stairs, the size of an obstacle, etc., such data may be transmitted via wired connection or wirelessly (e.g., Bluetooth, wifi) to processors at the processing unit of the crutches, an external server and/or exoskeleton device. In some embodiments, the processing unit may process the data to determine a response and generate signals for instructing the crutches and/or the exoskeleton to adjust according to the determined response. For example, once the height of a stair is determined (by the sensors or the processing unit, for example), the processing unit may calculate the magnitude, direction, orientation, etc., of the steps and/or movements of the exoskeleton and/or crutches that may lead to successful avoidance of the obstacle or climbing of the stairs. Further, based on these calculated values, the processing unit may generate and transmit instructions to the exoskeleton and/or the crutches so as to facilitate the mobility of the user in overcoming the aforementioned obstacles or stairs. In some embodiments, the processor may also display the instructions in the user interface (e.g., for the user's input). In some embodiments, the transmittance of data and/or instructions within and/or amongst the crutches and the exoskeleton may be carried out via a communications component onboard the crutches.

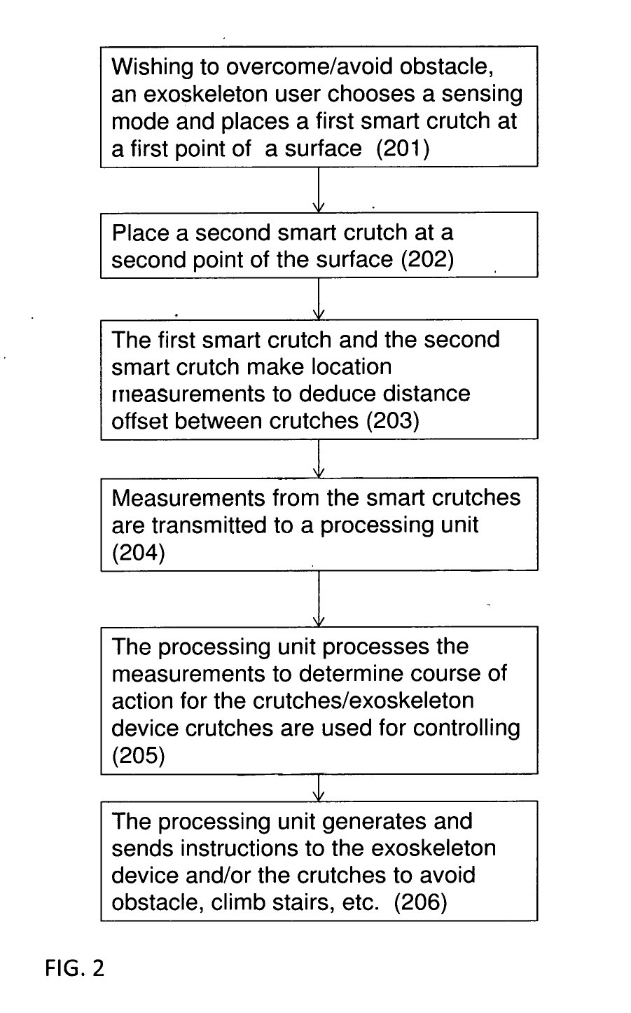

For example, with respect to FIG. 2, a user of the exoskeleton, faced with an obstacle or stairs along the path of the user, may wish to avoid or overcome the impediment. In some embodiments, the user may indicate his/her wish by making a selection on a crutch's user interface, and/or by engaging a user interface element (e.g., pushing a button, etc.) on the crutch, e.g., 201. Such a selection may dispose the crutch in a “sensing mode” where the sensors in the crutches are triggered to make measurements. In some embodiments, there may be a variety of modes for the user to choose from. For example, there may be a “stairs mode” indicating the impediments to overcome are stairs, a “puddle mode” indicating a body of water, a “corner mode” indicating edge of a building, an “obstacle mode” indicating a sizable object to be cleared over, etc. A selection of such modes allows the appropriate sensors to be triggered, and/or the sensors to sense according to the selected mode. For example, upon choosing the stairs mode, the user may place one crutch at one stair (e.g., base stair) and another crutch at another stair (e.g., next to base stair), e.g., 201 and 202. With the selection of the “stair mode,” in some embodiments, the sensors are triggered to measure the vertical offset between the crutches, which can be related to, by the sensors and/or the processing unit, the distance between the stairs, i.e., the height of a stair, e.g., 203.

In some embodiments, a communications component (e.g., transceiver, see above) may be utilized to transmit information corresponding to the measurements (for example) to the processing unit, e.g., 204. In some embodiments, the processing unit takes the selected mode into consideration when it generates instructions for the crutches and/or the exoskeleton, e.g., 205. For example, for a stair mode, the processing unit may instruct the exoskeleton to take a step with a clearance of the stair height without changing direction or orientation, e.g., 206.

In another example, the impediment on the user's pathway may be a puddle of water. In some embodiments, the “puddle mode” may allow the user to choose between skirting the puddle and determining its depth so as to decide whether to cross it or not. If the user chooses to determine the depth, for example, the sensors in the crutches may be triggered to measure the depth of the puddle in manner similar to measuring the height of a stair. Such a measurement may allow a processing unit to determine whether the puddle is too deep for traversing, and generate instructions to the exoskeleton and/or crutches based on the determination. If the selection was instead to skirt the puddle, the user may place the crutches at the edges of the puddle (e.g., one crutch each at two corners of the puddle), and the sensors in the crutches may be triggered to measure the width of the puddle. For example, the sensors in each crutch may communicate with each other to deduce the horizontal distance from each other, which then may be related to the width of the puddle. Based on such measurements, in some embodiments, the processing unit may determine the direction, speed, orientation, etc., of the exoskeleton's and/or crutches' movements, allowing the user to avoid the impediment (i.e., the puddle). These are exemplary embodiments, and similar considerations apply to other modes such as “obstacle mode” (determine the height and width of the obstacle so as to clear it when walking over it with the exoskeleton), “corner mode,” (changing direction, speed, orientation, etc., to avoid the corner), etc.

In some embodiments, the processor is also configured to receive signals from control elements on the handle of the crutches, and generate instructions to the exoskeleton and/or crutches to obey the signals. For example, the user may wish to modify the mobility of the exoskeleton by changing speed, direction, orientation, mobility mode (e.g., from a crowded area mobility mode to sparse area mobility mode, etc.), and/or the like, and the user may indicate such wishes by engaging control elements on the handle of the crutches. In some embodiments, the user may also input data into a user interface on the crutches. The engagement of the user with the control elements and/or user interface may generate signals encoding the user's wishes. For example, the user may wish to speed up the exoskeleton while in motion, and the user may engage a control element on a crutch to indicate the wish. For example, the user may push a button control element for accelerating the exoskeleton or may engage an acceleration/deceleration switch. In some embodiments, the processing unit may process the signals and instruct the exoskeleton to change its velocity accordingly. In some embodiments, the processing unit may override the signals from the user based on other parameters for reasons of safety, power availability, and/or the like. For example, the processing unit may decline to issue instructions to the exoskeleton if the requested acceleration exceeds a maximum threshold of acceleration or would lead to unacceptable velocity (or it may generate instructions to accelerate the exoskeleton at the maximum acceleration threshold, for example).

Various aspects of the exoskeleton device can also be found in the following US publications, all of which are incorporated by reference herein in their entireties:
U.S. Pat. No. 7,153,242, issued Dec. 26, 2006, filed May 24, 2001, and entitled “Gait-locomotor apparatus;”
U.S. Pat. No. 8,905,955, issued Dec. 9, 2014, filed Jan. 7, 2013, and entitled “Locomotion assisting device and method;”
US Patent Publication No. 2012/0101415, published Apr. 26, 2012, filed Oct. 21, 2010, and entitled “LOCOMOTION ASSISTING APPARATUS WITH INTEGRATED TILT SENSOR;”
US Patent Publication No. 2013/0253385, published Sep. 26, 2013, filed Mar. 21, 2012, and entitled “MOTORIZED EXOSKELETON UNIT;”
US Patent Publication No. 2014/0005577, published Jan. 2, 2014, filed Jun. 28, 2012, and entitled “AIRBAG FOR EXOSKELETON DEVICE;” and
US Patent Publication No. 2014/0196757, published Jul. 17, 2014, filed Jan. 17, 2013, and entitled “GAIT DEVICE WITH A CRUTCH.”

At least some of the embodiments described herein can be performed by or with the assistance of software (stored in memory and/or executed on hardware), hardware, or a combination thereof. Hardware modules may include, for example, a general-purpose processor, a field programmable gate array (FPGA), and/or an application specific integrated circuit (ASIC). Software modules (executed on hardware) can be expressed in a variety of software languages (e.g., computer code), including Unix utilities, C, C++, Java™, Ruby, SQL, SAS®, the R programming language/software environment, Visual Basic™, and other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. Additional examples of computer code include, but are not limited to, control signals, encrypted code, and compressed code. Each of the devices described herein can include one or more processors as described above.

Some embodiments described herein relate to devices with a non-transitory computer readable medium (also can be referred to as a non-transitory processor-readable medium or memory) having instructions or computer code thereon for performing various computer implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of non-transitory computer-readable media include, but are not limited to: magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other embodiments described herein relate to a computer program product, which can include, for example, the instructions and/or computer code discussed herein.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be an example and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, apparatus, device, article, material, kit, and/or method described herein. In addition, any combination of two or more such features, systems, apparatuses, devices, articles, materials, kits, and/or methods, if such features, systems, apparatuses, devices, articles, materials, kits, and/or methods are not mutually inconsistent, is included within the inventive scope of the present disclosure. Still further, some embodiments disclosed herein are distinguishable over prior art references by specifically lacking one or more features disclosed in the prior art; that is, claims to such embodiments may include negative limitations so as to be distinguished from the prior art.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Any and all references to publications or other documents, including but not limited to, patents, patent applications, articles, webpages, books, etc., presented anywhere in the present application, are herein incorporated by reference in their entirety. Moreover, all definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A crutch apparatus for at least aiding in the control of mobility of an exoskeleton device, comprising:
an elongated structural member configured with a first portion for grasping by a user of an exoskeleton device and a second portion configured to interact at least with a surface;
one or more first sensors for outputting signals corresponding to information of at least one of a location and a distance of the one or more sensors and/or crutch relative to at least one of a position, a location, and a surface, and outputting signals indicative thereof; and
communications means for communicating the signals to a processing unit.

2. The apparatus of claim 1, further comprising the processing unit.

3. The apparatus of claim 1, wherein the exoskeleton device includes the processing unit.

4. The apparatus of claim 1, wherein the communications means is operably coupled to at least one of the crutch, the exoskeleton device, and a remote unit.

5. The apparatus of claim 1, wherein the information corresponds to at least a distance between at least two of: the crutch, the ground, a second crutch, a horizontal surface, a lateral surface, and at least a portion of the exoskeleton device.

6. The apparatus of claim 1, wherein the information corresponds to at least a location of at least one of the crutch, the ground, a second crutch, a horizontal surface, a lateral surface, and at least a portion of the exoskeleton device.

7. The apparatus of claim 1, wherein the processing unit includes computer instructions operating thereon configured to at least one of process the signals and generate further instructions to control at least a mobility of the exoskeleton device.

8. The apparatus of claim 7, wherein the instructions to control at least a mobility of the exoskeleton device is based on the signals.

9. The apparatus of claim 1, further comprising one or more control elements configured to allow a user of the exoskeleton device to control at least one of a state of the exoskeleton device, a state of the crutch, and a state of a third device.

10. The apparatus of claim 9, wherein the state is selected from the group consisting of: on, off, stand-by, walk, sit, climb, stair, and velocity of the exoskeleton device.

11. The apparatus of claim 1, wherein the one or more first sensors comprise at least one or more of: pressure sensors, GPS sensors, gyroscopic sensors/devices, and radio-ID sensors/devices.

12. The apparatus of claim 1, wherein the one or more first sensors are arranged at or near a distal end of the crutch and are configured to at least sense contact or proximity of the distal end of the crutch with at least one of the ground, horizontal surface, and lateral surface and generate the signals responsive thereto.

13. The apparatus of claim 1, wherein the location or distance information comprises at least one of a size and shape of an obstacle on a pathway of at least one of the crutch and the exoskeleton device.

14. The apparatus of claim 1, wherein the location or distance information comprises a height of a stair on a pathway of at least one of the crutch and the exoskeleton device.

15. The apparatus of claim 1, wherein the one or more first sensors are configured to communicate with one or more second sensors of a second crutch via at least one of the communications means and second communication means.

16. The apparatus of claim 15, wherein the second crutch includes second crutch communications means for communicating with at least one of the communications means and/or second communication means of the crutch, and the processing unit.

17. The apparatus of claim 15, wherein the one or more second sensors generate second signals comprising information corresponding to at least one of location and distance of at least one of the one or more second sensors and at least a portion of the second crutch, and wherein the processing unit includes computer instructions operating thereon configured to at least one of process the signals from the one or more sensors, and the signals of the one or more second sensors of the second crutch and generate further instructions to control at least a mobility of the exoskeleton device.

18. The apparatus of claim 15, wherein the processing unit includes computer instructions operating thereon configured to at least one of process signals from the one or more sensors, and signals from the one or more second sensors of the second crutch and determine an offset distance between at least two of the crutch, the second crutch, and the exoskeleton device.

19. The apparatus of claim 18, wherein the offset distance comprises at least one of an elevation difference and a lateral distance.

20. The apparatus of claim 1, wherein the processing unit is provided on at least one of the crutch and the exoskeleton device.

21. The apparatus of claim 1, further comprising a user interface configured to at least one of: display information, provide data input, control and/or select a state of at least one of the crutch, a second crutch and the exoskeleton device.

22-39. (canceled)
